(19) United States
(12) Patent Application Publication
(10) Pub. No.: US 2025/0004099 A1
(43) Pub. Date: Jan. 2, 2025

(54) RADAR UPGRADE DEMONSTRATOR

(71) Applicant: General Radar Corporation, Belmont, CA (US)

(72) Inventors: Dmitry Turbiner, Dallas, TX (US); Jon Williams, San Francisco, CA (US); Amir Hirsch, San Francisco, CA (US); Brian Williams, Issaquah, WA (US)

(21) Appl. No.: 18/337,932

(22) Filed: Jun. 20, 2023

Related U.S. Application Data
(60) Provisional application No. 63/399,016, filed on Aug. 18, 2022.

(51) Int. Cl. G01S 7/32

(52) U.S. Cl. CPC G01S 7/32

(57) ABSTRACT

Methods, systems, and apparatus, including computer programs encoded on computer storage media, for demonstrating radar upgrade capabilities. One of the systems includes a radar upgrade demonstrator configured to connect to a preexisting radar antenna and having a high-resolution, long-range, SERDES pulse compression architecture.

### CROSS-REFERENCE TO RELATED APPLICATIONS

This application claims the benefit under 35 U.S.C. § 119(e) of the filing date of U.S. Provisional Patent Application No. 63/399,016, filed on Aug. 18, 2022, entitled “Radar Upgrade Demonstrator,” the entirety of which is herein incorporated by reference.

### GOVERNMENT LICENSE RIGHTS

This invention was made with government support under contract No. FA864920C0056 awarded by the Department of Defense and the United States Air Force. The government has certain rights in the invention.

### BACKGROUND

This specification relates to demonstrating the upgradability of legacy radar systems using a SERDES architecture with an FPGA-based signal processor.

Radar systems have historically been designed with very specific mission parameters, e.g., minimum and maximum range, target size, and aircraft type, to name just a few examples. From these mission parameters, the properties of the radar system are painstakingly designed, often manually. For example, the designers can use mission parameters to choose a power requirement, an antenna size, the design of transmit and receive elements, and required processing capabilities. Because radar systems are typically designed from scratch for a particular mission, it is usually difficult or impossible to modify the system to have different mission parameters. As one example, many legacy radar systems that were designed to detect airplanes that are 50 feet long with a 30-foot wingspan do not have the capability to detect drones that are only 1 foot in diameter.

### SUMMARY

This specification relates to demonstrating the upgradability of legacy radar systems. In particular, this specification describes a system that demonstrates that a high-speed serializer/deserializer (SERDES) architecture with a high-performance FPGA processing backend can be configured to process signals from a legacy radar system to improve its range, resolution, and detection reliability.

The processing gain and sampling frequency afforded by the SERDES Architecture may be separated from the overall radar system design. As such, existing radar systems with a given antenna, site, and power amplifier set could benefit from a “plug-in” SERDES signal processor that would offer enhanced functionality without sacrificing high cost investments or redesigns.

Thus the concept of upgrading a radar system can be demonstrated with a high-performance FPGA-based radar signal processor back-end coupled into an existing radar RF front-end that allows for programmable increases in performance and standardized interfaces to a variety of existing radar systems. In addition, the demonstrator described in this specification can perform variable code-length and associated correlation at extremely high sample rates. By incorporation into an already operating RF chain, range resolution and target sensitivity can be enhanced through utilization of digital processing power in appropriate manners.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example architecture of a radar upgrade demonstrator.

FIG. 2 is an illustration of an antenna of an example radar upgrade demonstrator.

FIG. 3 illustrates an RF circuit of an example radar upgrade demonstrator.

FIG. 4 illustrates an example radar upgrade demonstrator.

FIGS. 5A, 5B, 5C, and 5D illustrate the improvement in resolution of the radar upgrade demonstrator relative to a legacy radar system.

FIG. 6 illustrates another example of detecting drones relative to a legacy radar system.

Like reference numbers and designations in the various drawings indicate like elements.

### DETAILED DESCRIPTION

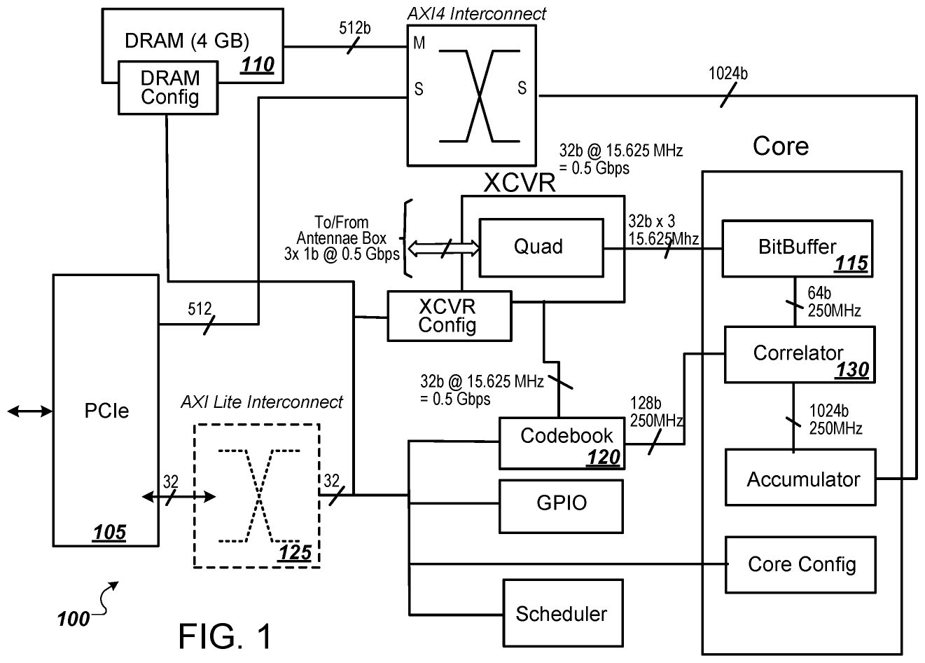

FIG. 1 is a diagram that illustrates an example architecture 100 of a radar upgrade demonstrator. The prototype radar upgrade demonstrator runs on a Xilinx Ultrascale+FPGA VCU 128 board, using the FPGA GTY 28 Gbps transceivers to generate pulses for transmission and to receive the response for correlation.

The FPGA system connects to the host computer via a PCIe 105, and to the analog frontend via SMA connectors. After accumulating several trials, the correlator dumps an echogram to a DDR4 RAM 110 where it is retrieved by the host computer. A PCIe DMA to AXI4 bus IP is used to receive echogram data at high bandwidth from RAM and the lower bandwidth AXI Lite bus is used to send setup and control signals to the FPGA.

The example system is an X-Band system that uses a relatively low SERDES sampling rate of 500 Mbps. The SERDES can consume and produce 32-bits of data at 15.625 MHz (500/32=15.625). The response data is recorded into a double-buffer called the bitbuffer 115, recording to one bank while processing the previously recorded data in another bank.

Pseudorandom codes are loaded into a dual-channel RAM codebook 120. One channel of the codebook 120 has a 32-bit bus written to by the Host PC via AXI-Lite Interconnect 125 and read out by the SERDES at 15.625 MHz, and the other codebook channel is a 128-bit bus to load the code into the correlator 130.

The scheduler block counts the codebook address and bitbuffer address, and signals to the correlator 130 when to start processing a trial.

The correlator processes data at 250 MHz, comparing the bits for a 1024-bit code against the recorded data at 64 different time shifts each clock cycle and accumulating the number of matching bits into an echogram buffer. The system scans 32,768 bits for a 1024 bit code in 512 clock cycles and then loads another chunk of the code. Each trial, the system scans a 65,536 bit window for 32,768 bit codewords in 16,384+256 clock cycles (with the additional 256 cycles from using 8 clock cycles to load each of 32 different 1024-bit codeword chunks 128-bits at a time). Since at 500 Mbps each bit corresponds to a foot of distance (500 Mbps=2 feet of signal time-of-flight per bit, half this for distance to target) this translates to continuously scanning a 32,768 foot window in real time with accuracy to a foot.

To increase range, the bit buffer 115 can record longer responses and the correlator 130 can scan larger ranges in less than real time or the range can be windowed. Alternatively, the system could simply use parallel correlator resources to scan different ranges. As can be seen in the implementation layout in FIG. 1, this particular FPGA has space for five more of the correlator implementations and multiple channels can include scanning correlators for the Elevation and Azimuth channels. However, it is typically unnecessary to scan these channels after a peak has been found in the Sum channel so these correlators can be considered optional.

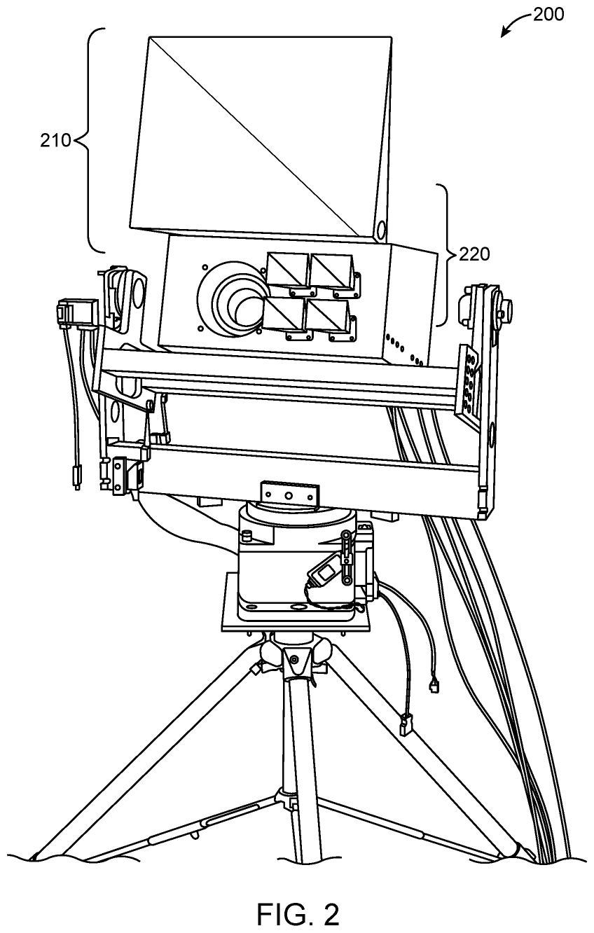

FIG. 2 is an illustration of an antenna 200 of an example radar upgrade demonstrator. The antenna design utilizes microwave horns with one transmitter waveguide 210 and four receiver waveguides 220 arranged in a 4 channel monopulse comparator configuration. The transmit horn 210 has 20 dBi of gain with a 16 degree 3 dB beamwidth and the receive horns 220 have 15 dBi of gain with an 18 degree 3 dB beamwidth. They are mounted coplanar and are gimballed on a leveled tripod with angular readout indications.

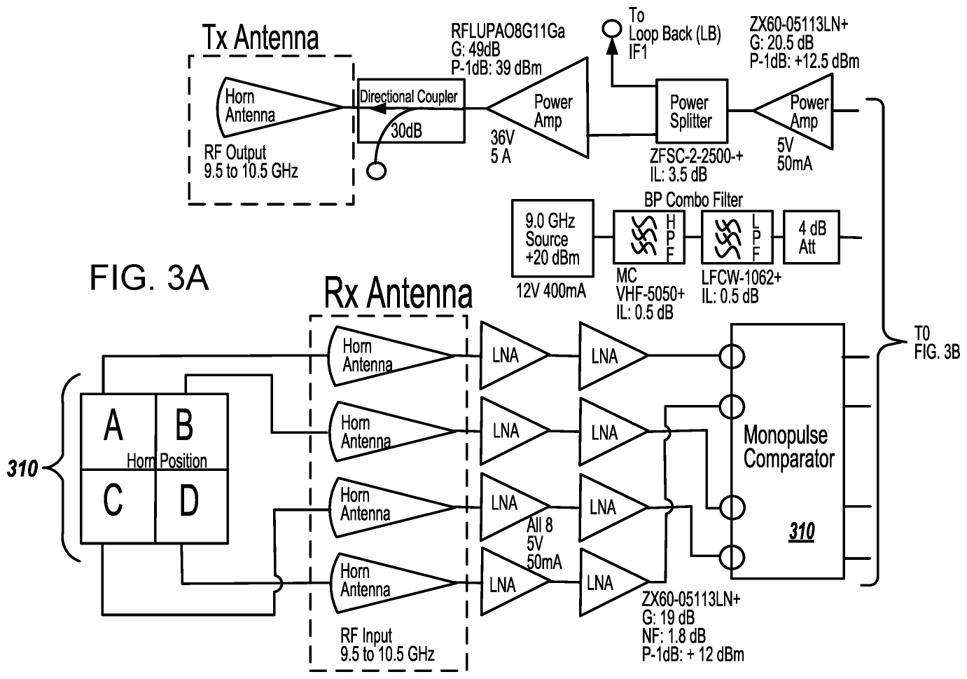

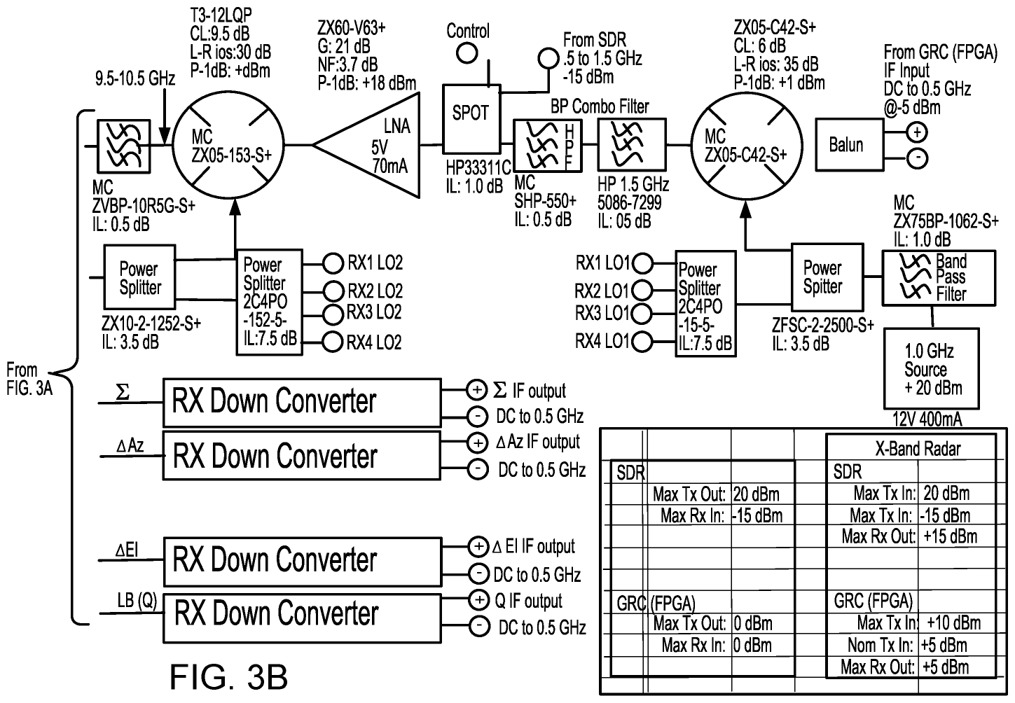

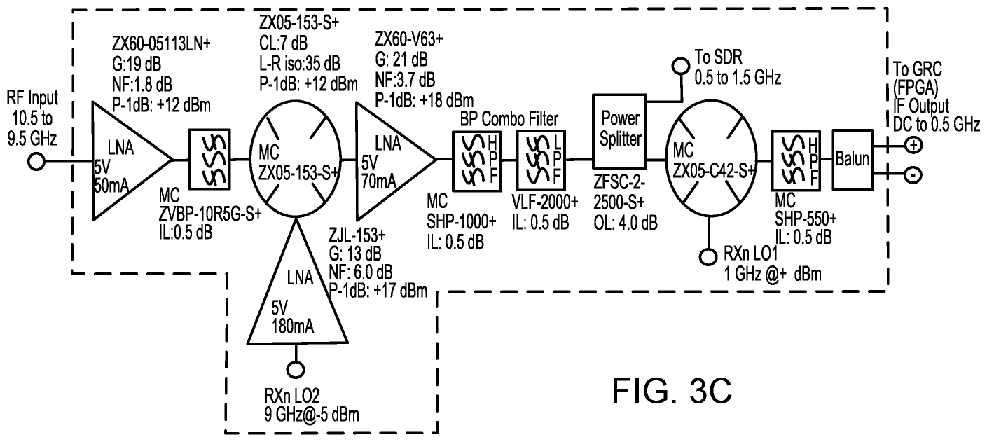

FIG. 3 illustrates an RF circuit 300 of an example radar upgrade demonstrator. The four receiver horns 220 are presented in the “ABCD” quad 310, feeding the monopulse comparator 320 and outputting sum, azimuth, and elevation, and phase information. Each channel is down converted through the IF chain, and coupled to the FPGA block.

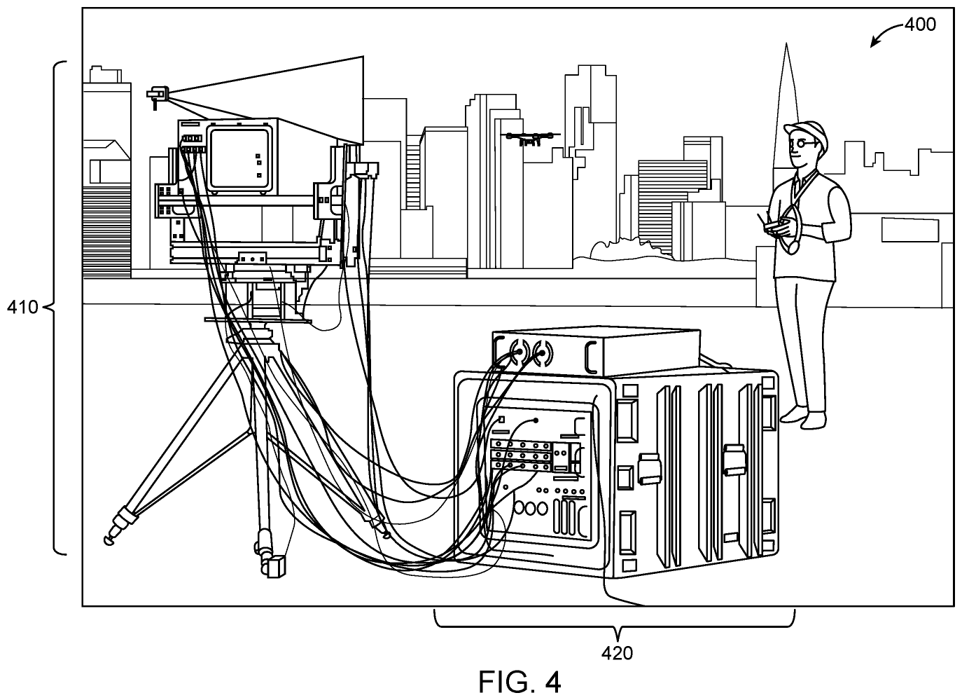

FIG. 4 illustrates an example radar upgrade demonstrator 400. The demonstrator 400 includes an antenna subsystem 410 coupled to a backend processing module 420. In operation, the antenna subsystem 410 can emulate the characteristics of a legacy radar system. The backend processing module 420 can then process the signals generated by the antenna subsystem 410 in order to demonstrate that the legacy radar system could be enhanced by merely connecting the backend processing module 420 or equivalent processing equipment.

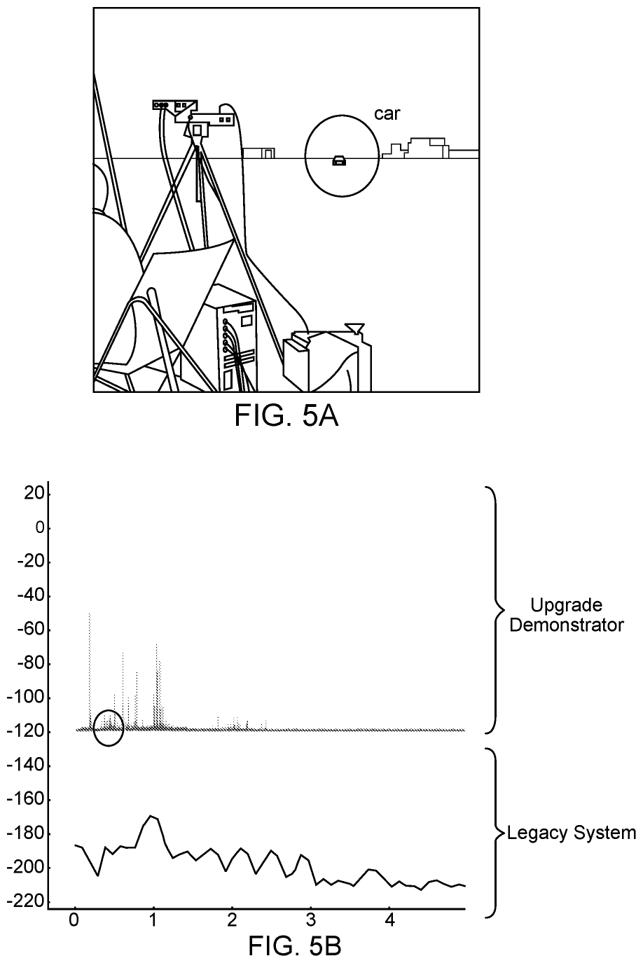

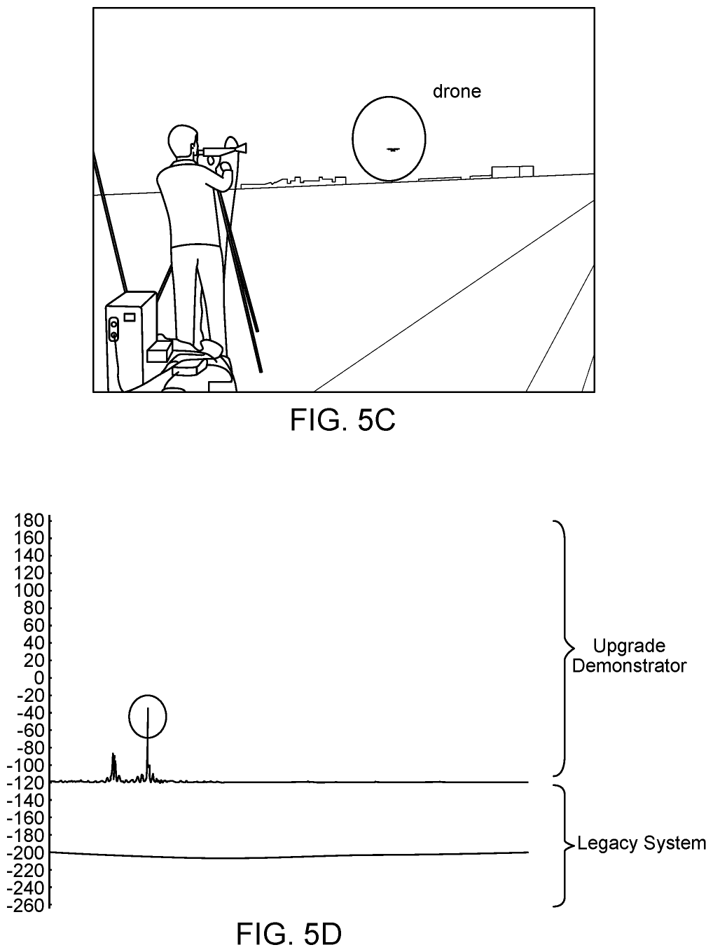

FIGS. 5A and 5B illustrate the improvement in resolution of the radar upgrade demonstrator relative to a legacy D-RAPCON system. The Deployable Radar Approach Control (D-RAPCON) system is a currently fielded radar system whose air traffic control characteristics can be emulated from unclassified sample data.

As shown in FIGS. 5A and 5B, in an actual demonstration at the Alameda Naval Air Station, the upgrade demonstrator was able to pick up returns from a car parked on the runway, while the emulated D-RAPCON system did not.

FIGS. 5C and 5D illustrate another example using a drone. In this example, the upgrade demonstrator was able to detect a drone, while the emulated D-RAPCON system was not. These results demonstrate that the legacy D-RAPCON system could potentially be upgraded with the ability to detect drones.

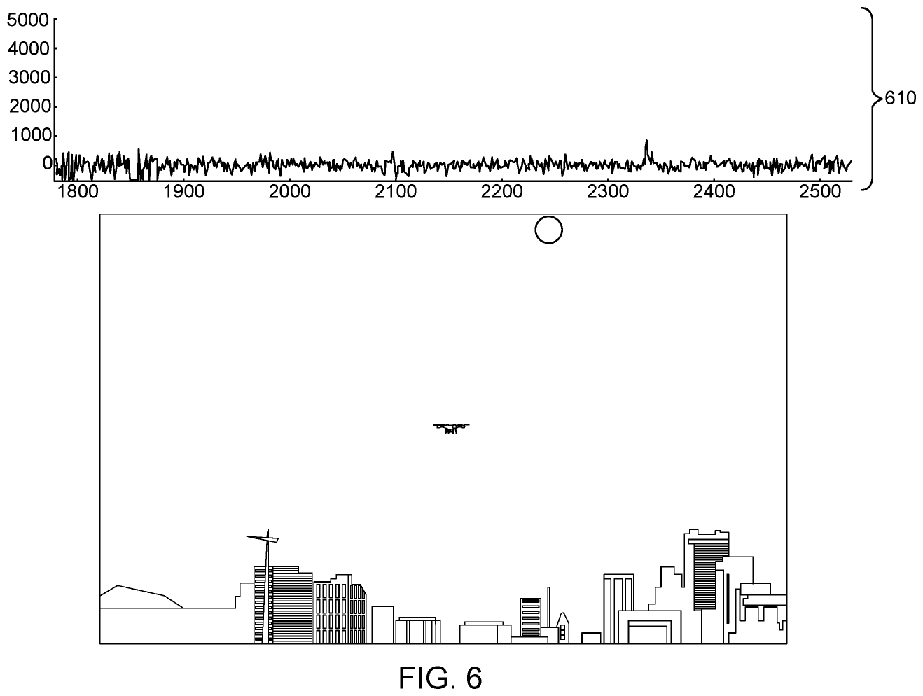

FIG. 6 illustrates another drone example. In this example, the radar upgrade demonstrator returns 610 correctly detected a drone at 2350 meters.

TABLE 1 summarizes comparative testing between the emulated D-RAPCON system and the SERDES/FPGA upgrade demonstrator. As indicated, using the SERDES/FPGA architecture resulted in a 200× greater range resolution.

| | | | SERDES/FPGA | | |
|---|---|---|---|---|---|
| Specification | D-RAPCON | | Upgrade Demonstrator | | NOTES |
| Sample Rate | 2.56 | MSPS | 500 | MSPS | Results in |

| | | | | 1 GHz of |
|---|---|---|---|---|
| | | | | modulation |
| | | | | BW. Can be |
| | | | | reduced for |
| | | | | other bands |
| | | | | such as L |
| | | | | and S |
| Distance | 115 m ( 1/16 | 0.6 | m | 200x greater |
| Resolution | nmi) | | | range resolution |

| Pulse Type | Non Linear | | 1024 (short) |
|---|---|---|---|
| | FM (NLFM) | | or 32,768 (long) |
| | chirp | | BPSK PRN sequence |
| Pulse Length | 89 | us | 2 us (short) |

or 65 us (long)

The primary gain in performance is the remarkable 200× improvement in range resolution offered by the SERDES/FPGA signal processing. Such sub-meter resolution allows association between return signal strength and individualized features.

Environmental “noise” such as ground clutter can be more accurately assessed and filtered out of a scene with such a detailed image. Where structure within a range gate would provide a varied and difficult signal to manage as an image, improved resolution drives a far superior basis function for static scene subtraction.

High resolution also allows detection of small targets having a cross section under 1 meter (e.g. humans, cars, quadcopter drones) or difficult targets (such as Hypersonic Vehicles with Plasma Sheaths).

Unexpected signal behaviors are also far easier to manage with such high resolution, including multi-target tracking and unusual behaviors and dynamics. In both cases, finely structured details of the radar image are crucial to powering predictive capabilities in the total tracking system. Lower resolution imposes predictive limitations on model updates due to the coarse spacing, and therefore input bandwidth, for any multi-target discrimination or highly maneuverable target tracking.

In working with the radar upgrade demonstrator, unique features are born on both signal processing capability and overall system maintenance. Further verified is the ability of the FPGA system to directly plug into either the transceiver outputs or the IF outputs to handle RF interfacing while providing a standardized PCIe computer bus interface. Together, a truly universal radar upgrade demonstrator with long-term sustainable application and maintenance and increased performance is delivered.

With regard to system maintenance, the modern FPGA based Genrad backend allows for a computer to directly couple, commission, command and control a powerful radar signal processor. The expansion of this ideas allows for development of programmatic radar functionality to be built into any existing radar installation, enabling features such as varying code/listen lengths, active/passive modes, spectroscopy,

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, subprograms, or portions of code. A computer program can be deployed to be executed on one computer or on multiple computers that are located at one site or distributed across multiple sites and interconnected by a communication network.

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magnetooptical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magnetooptical disks; and CD-ROM and DVD-ROM disks. The processor and the memory can be supplemented by, or incorporated in, special purpose logic circuitry.

Embodiments of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), e.g., the Internet.

While this specification contains specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

Certain novel aspects of the subject matter of this specification are set forth in the claim below, accompanied by further description in Appendix A.

What is claimed is:

1. A radar upgrade demonstrator configured to connect to a preexisting radar antenna and having a high-resolution, long-range, SERDES pulse compression architecture.

2. The radar upgrade demonstrator of claim 1, further comprising an FPGA processing backend.

3. The radar upgrade demonstrator of claim 1, further comprising a transmit horn and a plurality of receiver horns.

4. The radar upgrade demonstrator of claim 2, wherein the processing backend is configured to pass signals received by the receiver horns through a monopulse comparator to output sum, azimuth, and elevation information.

5. The radar upgrade demonstrator of claim 4, wherein the monopulse comparator is configured to output phase information.

6. The radar upgrade demonstrator of claim 1, wherein the radar upgrade demonstrator is configured to provide a legacy radar system with the capability to detect targets having a cross section under 1 meter.

7. The radar upgrade demonstrator of claim 1, further comprising a correlator that compares a code against received data at a plurality of different time shifts at each of a plurality of clock cycles.

8. The radar upgrade demonstrator of claim 7, wherein the correlator is configured to accumulate matching bits into an echogram buffer.

9. A method performed by a radar upgrade demonstrator comprising a high-resolution, long-range, SERDES pulse compression architecture, the method comprising:
comparing a code against received data at a plurality of different time shifts at each of a plurality of clock cycles.

10. The method of claim 9, further comprising: accumulating matching bits into an echogram buffer.

11. The method of claim 9, further comprising:
passing, by a processing backend, signals received by one or more receiver horns through a monopulse comparator to output sum, azimuth, and elevation information.

12. The method of claim 11, further comprising outputting phase information.
